(19) United States
(12) Patent Application Publication
(10) Pub. No.: US 2015/0343472 A1
(43) Pub. Date: Dec. 3, 2015

(54) TRIGGER TYPE SPRAYER

(71) Applicant: CANYON CO., LTD., Yamaguchi (JP)

(72) Inventors: Tetsuya TADA, Tokyo (JP); Tomichika FURUTANI, Sanyo Onoda-shi, Yamaguchi (JP)

(21) Appl. No.: 14/655,004

(22) PCT Filed: Dec. 24, 2013
(86) PCT No.: PCT/JP2013/007555

§ 371 Date: Jun. 23, 2015

(30) Foreign Application Priority Data
Dec. 29, 2012 (JP) 2012-289195

(51) Int. Cl. B05B 11/00

(52) U.S. Cl. CPC B05B 11/3023; B05B 11/3011; B05B 11/3066

(57) ABSTRACT

A trigger type sprayer capable of easily performing air vent in a space between a second valve and a first valve, and preventing leakage of liquid in use is provided.

The present invention includes a body 11 having a first flow channel 11a through which liquid can flow, a second flow channel 11d communicating with the first flow channel 11a, and a cylindrical cylinder chamber 11b communicating with the second flow channel 11d; a hollow piston 13 slidably incorporated into the cylinder chamber 11b, having a valve seat 13b and a hollow portion 13d of a second valve 14, and sliding back and forth according to operation of a trigger 12; the second valve 14 incorporated into the hollow portion 13d of the hollow piston 13 and positioned at a downstream side; and a first valve 15 incorporated into the cylinder chamber 11b and positioned at an upstream side, wherein the first valve 15 is pressed by the second valve 14 so that the first valve 15 is opened.

### TECHNICAL FIELD

The present invention relates to a trigger type sprayer, and in particular to a trigger type sprayer capable of easily performing air vent in a space between a second valve and a first valve.

### BACKGROUND ART

Conventionally, as an example of a trigger type sprayer, one disclosed in PTL 1 has been suggested.

This one disclosed in PTL 1 relates to a trigger type liquid spraying device achieving reduction in number of idle triggering actions at the time of initial actuation, or the like, so that air vent in a pump can be easily performed, and capable of in-use smooth liquid spraying operation and uniform spraying, and an outline thereof has such a structure as described below.

That is, in a trigger type liquid spraying device provided with a trigger (I) causing a cylinder (13) to communicate with an intermediate portion of a liquid flow channel provided in a main body (B) and performing pressing-in operation of a plunger (H) sliding in the cylinder (13) and configured so as to spray liquid within a container from a nozzle (J) at a terminal end of the liquid channel according to operation of the trigger (I), a pressure accumulation type delivery valve (53) that brings a delivery valve body (G) which is always biased to an upstream side into pressure contact with a delivery valve seat (40) to define a closed region between the delivery valve (53) and a suction valve (23) is provided within an injection cylinder (12) constituting a portion of the liquid flow channel and having a distal end fitted with the nozzle (J), and an air relief groove (41) causing upstream and downstream flows to communicate with each other is provided in at least one of the delivery valve seat (40) and the delivery valve body (G).

### CITATION LIST

### Patent Literature

PTL 1: Japanese Patent No. 4947591

### SUMMARY OF INVENTION

### Technical Problem

However, in the trigger type liquid spraying device disclosed in PTL 1 described above, since either one of the delivery valve seat 40 (corresponding to a valve seat 13b of a second valve 14 in the present invention) and a delivery valve body G (corresponding a valve body 14c of the second valve 14 in the present invention) is provided with the air relief groove 41 allowing communication of upstream and downstream flows, there is such a problem that liquid may leak through the air relief groove 41 during use even if the air relief groove 41 is minute.

Further, in conventional trigger type spraying devices, including the trigger type liquid spraying device disclosed in PTL 1 described above, it is common that opening and closing a value are performed by moving a valve body in an axial direction.

The present invention has been made in view of these circumstances, and an object of thereof is to provide a trigger type sprayer capable of easily performing air vent in a space between a second valve and a first valve and preventing leakage of liquid during use.

### Solution to Problems

The present inventors have conducted intensive research in order to solve the above problem, and, unexpectedly, have found that the above problem can be solved by inclining a valve body of a first valve to open the first valve, and have completed the present invention.

The present invention lies in (1) a trigger type sprayer including: a body having a first flow channel through which liquid can flow, a second flow channel communicating with the first flow channel, and a cylindrical cylinder chamber communicating with the second flow channel; a hollow piston slidably incorporated into the cylinder chamber, having a valve seat and a hollow portion of a second valve, and sliding back and forth according to operation of a trigger; the second valve incorporated into the hollow portion of the hollow piston and positioned at a downstream side; and a first valve incorporated into the cylinder chamber and positioned at an upstream side, wherein the first valve is pressed by the second valve so that the first valve is opened.

The present invention lies in (2) the trigger type sprayer according to the above (1), wherein the second valve has a pressure accumulation function, and is provided with a valve body, a spring, and a bottomed cylindrical case housing the valve body and the spring and attached inside the hollow portion, wherein the first valve is provided with a cylindrical case, a downstream side of which is opened and an upstream side of which is attached in the cylinder chamber, and a valve body positioned at the upstream side of the cylindrical case, wherein the bottomed cylindrical case is slidably incorporated into the cylindrical case, and slides back and forth together with the hollow piston according to operation of the trigger, and wherein the valve body of the first valve is pressed and inclined by a bottom portion of the bottomed cylindrical case so that the first valve is opened.

The present invention lies in (3) the trigger type sprayer according to the above (2), wherein an inclined face is formed on a face on a downstream side of the valve body of the first valve.

The present invention lies in (4) the trigger type sprayer according to the above (2), wherein an inclined face is formed on a face on an upstream side of the bottom portion of the bottomed cylindrical case of the second valve.

The present invention lies in (5) the trigger type sprayer according to the above (2), wherein a protrusion is formed on a face on an upstream side of the bottom portion of the bottomed cylindrical case of the second valve.

The present invention lies in (6) the trigger type sprayer according to the above (2), wherein a cam portion is formed on a face on an upstream side of the bottom portion of the bottomed cylindrical case of the second valve, and a lever provided with a cam portion is attached to a side of the valve body of the first valve so as to extend downstream.

The present invention lies in (7) the trigger type sprayer according to the above (1), wherein the second valve is of a direct pressure type having no pressure accumulation function.

It should be noted that, a configuration made by combining the above (1) to (7) suitably can also be adopted, as long as the configuration suits the object of the present invention.

### Advantageous Effects of Invention

The trigger type sprayer of the present invention has the following advantageous effect.

Since the trigger type sprayer of the present invention is a trigger type sprayer including: a body having a first flow channel through which liquid can flow, a second flow channel communicating with the first flow channel, and a cylindrical cylinder chamber communicating with the second flow channel; a hollow piston slidably incorporated into the cylinder chamber, having a valve seat and a hollow portion of a second valve, and sliding back and forth according to operation of a trigger; the second valve incorporated into the hollow piston and positioned at a downstream side; and a first valve incorporated into the cylinder chamber and positioned at an upstream side, wherein the first valve is pressed by the second valve so that the first valve is opened, when the trigger is fully pulled, the bottomed cylindrical case of the second valve slides to an upstream side together with the hollow piston, and the valve body of the first valve to is pressed to be inclined by a bottom portion of the bottomed cylindrical case so that the first valve is opened.

Therefore, air in a space between the second valve and the first valve passes through the first valve, and is discharged into a container, not shown, via the second flow channel and the first flow channel.

In addition, since the second valve is closed during discharge of air in a space between the second valve and the first valve, namely, during air vent, liquid never leaks from the nozzle.

Therefore, by several actions of pulling the trigger (namely, several idle triggering actions), all air vent in a space between the second valve and the first valve can be efficiently performed.

### BRIEF DESCRIPTION OF DRAWINGS

FIG. 1 is a sectional view of an essential part before a trigger of a trigger type sprayer according to an embodiment of the present invention is pulled;

FIG. 2 is a sectional view of the essential part after the trigger of the trigger type sprayer according to the embodiment of the present invention has been fully pulled;

FIG. 3 is an exploded view of the essential part of the trigger type sprayer according to the embodiment of the present invention;

FIG. 4 is a sectional view of a body shown in FIG. 3;

FIGS. 5(A) to 5(C) show a hollow piston shown in FIG. 3, FIG. 5(A) being a front view of the hollow piston. FIG. 5(B) being a left side view thereof, FIG. 5(C) being a right side view thereof;

FIGS. 6(A) to 6(D) show a cylindrical case of a first valve shown in FIG. 3, FIG. 6(A) being a front view of the cylindrical case, FIG. 6(B) being a left side view thereof, FIG. 6(C) being a right side view thereof, FIG. 6(D) being an axial sectional view thereof;

FIGS. 7(A) and 7(B) show an essential part of the first valve shown in FIG. 1 in an enlarged manner, FIG. 7(A) being an enlarged sectional view of the essential part including a valve body, FIG. 7(B) being a left side view thereof;

FIGS. 8(A) and 8(B) show opened and closed states of the first valve in the trigger type sprayer according to the embodiment of the present invention, FIG. 8(A) being an enlarged view of the inside of a circle X in FIG. 1, showing a state before the trigger is pulled, FIG. 8(B) being an enlarged view of the inside of a circle Y in FIG. 2, showing a state after the trigger has been fully pulled:

FIGS. 9(A) and 9(B) schematically show actuation of a first variation of the trigger type sprayer according to the embodiment of the present invention, FIG. 9(A) showing a state before the trigger is pulled, FIG. 9(B) showing a state after the trigger has been fully pulled;

FIGS. 10(A) and 10(B) schematically show actuation of a second variation of the trigger type sprayer according to the embodiment of the present invention, FIG. 10(A) showing a state before the trigger is pulled, FIG. 10(B) showing a state after the trigger has been fully pulled:

FIGS. 11(A) and 1 (B) schematically show actuation of a third variation of the trigger type sprayer according to the embodiment of the present invention, FIG. 11(A) showing a state before the trigger is pulled, FIG. 11(B) showing a state after the trigger has been fully pulled; and

FIGS. 12(A) and 12(B) schematically show actuation of a fourth variation where a means for inclining a valve body of the first valve of the present invention is applied to a direct pressure type trigger type sprayer, FIG. 12(A) showing a state before the trigger is pulled, FIG. 12(B) being a state after the trigger has been fully pulled.

### DESCRIPTION OF EMBODIMENTS

A trigger type sprayer 10 according to an embodiment of the present invention will be described below with reference to the drawings.

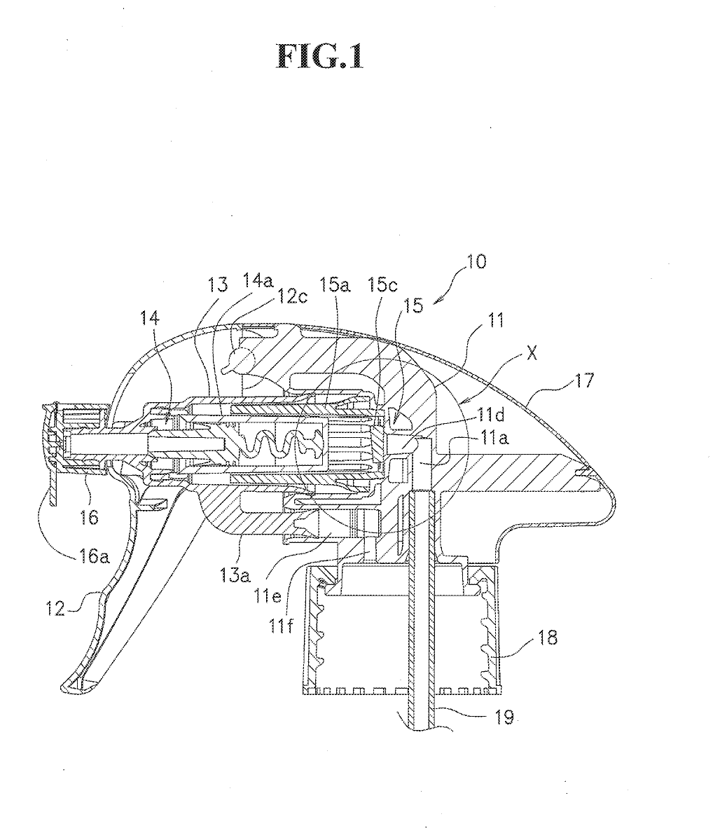

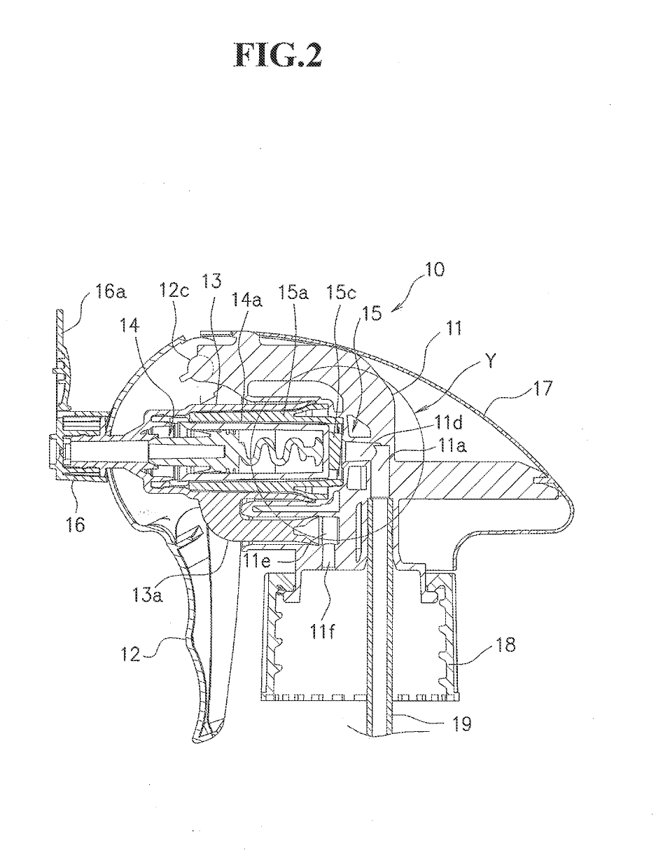

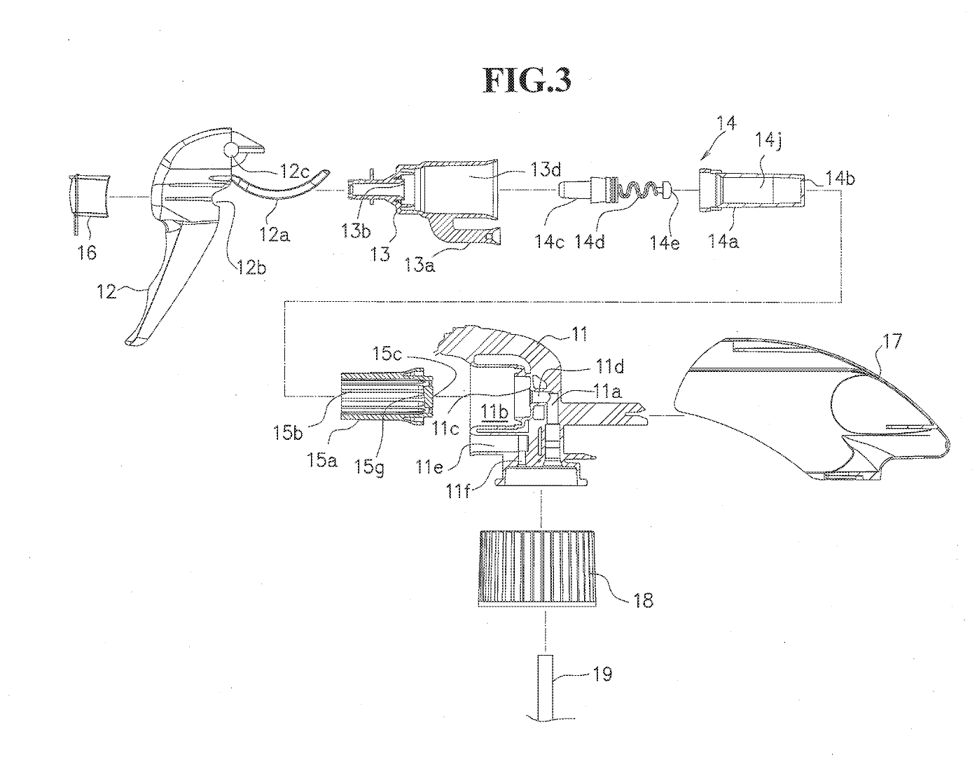

In FIG. 1, FIG. 2 are sectional views of an essential part of the trigger type sprayer 10 made by assembling individual components shown in FIG. 3 (an exploded view of the essential part), FIG. 1 being a sectional view before a trigger 12 is pulled, FIG. 2 being a sectional view after the trigger 12 has been fully pulled. FIG. 1, FIG. 2 both omitting a container to which a cap 18 is attached.

That is, a container containing liquid is not shown.

The trigger type sprayer 10 has a nozzle 16 having a nozzle cover 16a, a hollow piston 13, a bottomed cylindrical case 14a, a valve body 14c of a second valve 14 and a spring 14d biasing the valve body constituting the second valve, a cylindrical case 15a constituting a first valve 15, a body 11, a cover 17 of the body 11, the cap 18, and a suction tube 19.

The cap 18, as shown in FIG. 1, FIG. 2, has an upper portion attached to a lower portion of the body 11 in an airtight manner, and this cap 18 is attached to the container containing liquid, not shown, by screwing or the like.

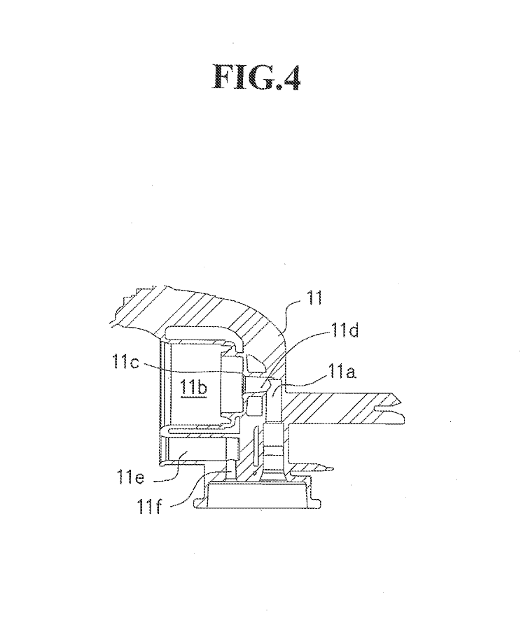

The body 11, as shown in FIG. 4, is provided with a vertical first flow channel portion 11a, a cylinder chamber 11b, a valve seat 11c of the first valve, a horizontal second flow channel portion 11d, a secondary cylinder chamber 11e, and an air flow channel 11f.

The trigger 12, as shown in FIG. 3, is provided with a return plate spring 12a, and a fitting portion 12b fitted with a pair of diametrical support shafts 13c of the hollow piston 13 described later, and, as shown in FIG. 1, FIG. 2, it is pivotally attached to the body 11 via a hinge portion 12c.

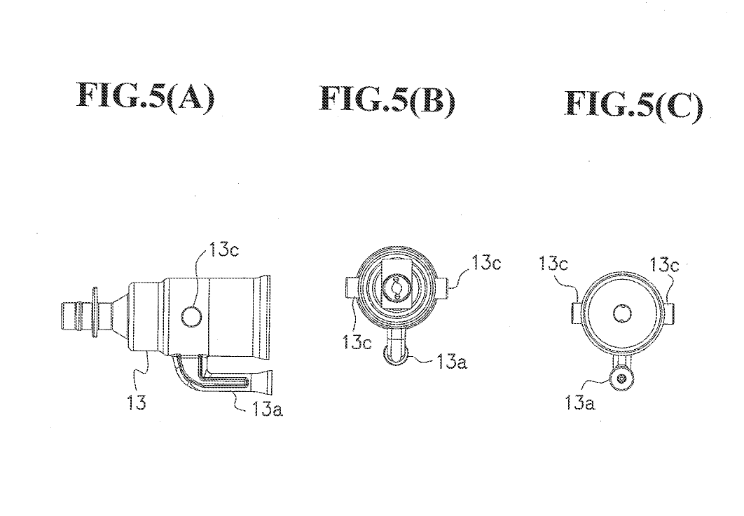

The hollow piston 13, as shown in FIG. 3, FIG. 5, is provided with a negative pressure relief piston 13a, a valve seat 13b of the second valve, the pair of diametrical support shafts 13c, and a hollow portion 13d.

Further, the hollow piston 13 and the negative pressure relief piston 13a are slidably fitted in the cylinder chamber 11b and the secondary cylinder chamber 11e, respectively.

The second valve 14, as shown in FIG. 1, FIG. 2 and FIG. 3, is provided with the bottomed cylindrical case 14a, the valve body 14c of the second valve, the spring 14d biasing the valve body 14c, and an abutting portion 14e, the valve body 14c of the second valve, the spring 14d biasing the valve body 14c, and the abutting portion 14e are incorporated into a hollow portion 14j of the bottomed cylindrical case 14a, and the valve body 14c biased by the spring 14d abuts on the valve seat 13b of the second valve 14 formed in the hollow piston 13.

Therefore, the second valve 14 has a pressure accumulation function.

Further, the bottomed cylindrical case 14a incorporated with these members has a downstream side attached inside the hollow portion 13d of the hollow piston 13.

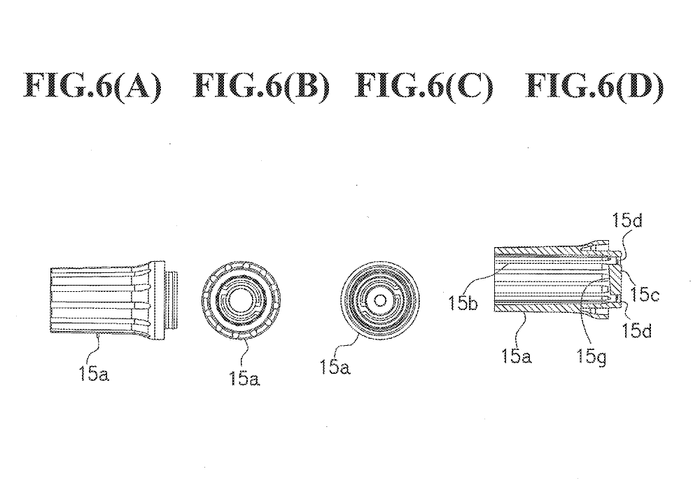

Now, the cylindrical case 15a constituting the first valve 15, as shown in FIG. 6(A). FIG. 6(B), FIG. 6(C), is provided with a plurality of axial grooves 15b formed in an inner face of the cylindrical case 15a, a valve body 15c of the first valve, and a plurality of plate spring portions 15d biasing the valve body 15c.

Further, the cylindrical case 15a has a downstream side opened and an upstream side attached inside the cylinder chamber 11b. and has the valve body 15c supported on the inner face at the upstream side via the plurality of plate spring portions 15d.

Further, as shown in FIG. 1, FIG. 2, the bottomed cylindrical case 14a having the hollow portion 14j incorporated with the valve body 14c of the second valve, the spring 14d biasing the valve body 14c, and the abutting portion 14e is inserted so as to be capable of sliding back and forth in the cylindrical case 15a constituting the first valve 15.

In addition, the cylindrical case 15a inserted with the bottomed cylindrical case 14a is attached at the upstream side thereof to the inside of the cylinder chamber 11b of the body 11.

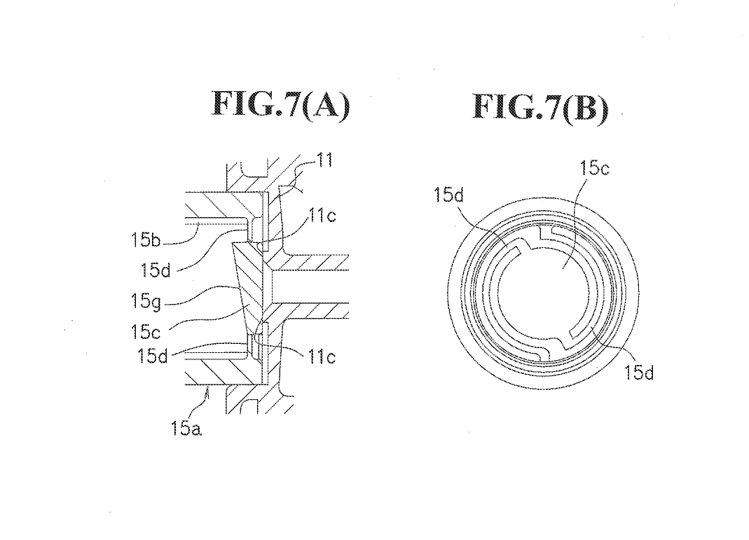

As shown in FIG. 7(A), at an end portion on an upstream side of the cylindrical case 15a, the valve body 15c is supported by the plurality of plate spring portions 15d biasing the valve body 15c, and the valve body 15c and the plate spring portions 15d are coupled to each other, as shown in FIG. 7(B).

Further, the valve body 15c is formed with an inclined face 15g on a face on the downstream side.

Further, as described later, the valve body 15c can incline against a biasing force of the plate spring portions 15d by a pressing force from a bottom portion 14b of the bottomed cylindrical case 14a, and the valve body 15c can return to an original position according to the biasing force of the plate spring portions 15d when the pressing force from the bottom portion 14b of the bottom cylindrical case 14a is lost.

Further, as shown in FIG. 7(A), when the pressing force from the bottom portion 14b of the bottomed cylindrical case 14a is lost, a face on the upstream side of the valve body 15c abuts on the valve seat 11c of the first valve 15 according to the biasing force of the plate spring portions 15d.

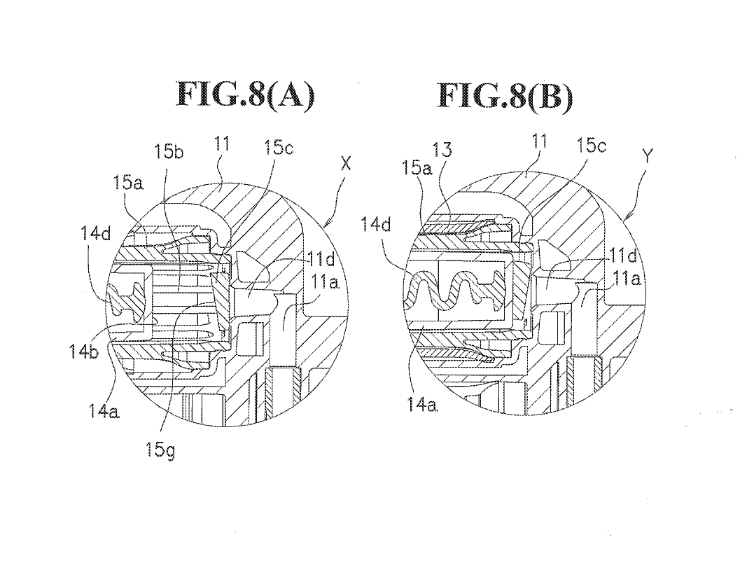

FIGS. 8(A) and 8(B) show opened and closed states of the first valve 15 in the trigger type sprayer 10 according to the embodiment of the present invention. FIG. 8(A) being an enlarged view of the inside of a circle X in FIG. 1, showing a state before the trigger 12 is pulled, FIG. 8(B) being an enlarged view of the inside of a circle Y in FIG. 2, showing a state after the trigger 12 has been fully pulled.

As shown in FIG. 8(A), in the state before the trigger 12 is fully pulled, the valve body 15c abuts on the valve sheet 11c of the first valve 15 according to the biasing force of the plate spring portions 15d so that the first valve 15 is closed.

As shown in FIG. 8(B), in the state after the trigger 12 has been pulled, the inclined face 15g of the valve body 15c is pressed by the bottom portion 14b of the bottomed cylindrical case 14a, and the valve body 15c is inclined against the biasing force of the plate spring portions 15d, so that a gap occurs between the valve body 15c and the valve seat 11c of the first valve 15 and the first valve 15 is opened.

In this regard, in order to incline the valve body 15c by pressing a portion thereof, such a soft material as to cause the valve body itself to deflect easily is not suitable, and a certain degree of rigidity is required.

Next, an air vent action of the trigger type sprayer 10 according to the embodiment of the present invention will be described below.

In an initial state before the air vent action is performed, namely, in the state before the trigger 12 is pulled, as shown in FIG. 1, specifically, as shown in FIG. 7(A). FIG. 8(A), the valve body 15c of the first valve 15 abuts on the valve seat 11c of the first valve 15 according to the biasing force of the plate spring portions 15d so that the first valve 15 is closed.

Subsequently, when the trigger 12 is fully pulled, as shown in FIG. 2, specifically, as shown in FIG. 8(B), the hollow piston 13 slides to the upstream side in the cylinder chamber 11b of the body 11. At this time, the bottomed cylindrical case 14a also slides to the upstream side together with the hollow piston 13.

Further, when the bottomed cylindrical case 14a slides to the upstream side, the bottom portion 14b of the bottomed cylindrical case 14a presses a higher portion (so-called apex portion) of the inclined face 15g of the valve body 15c.

That is, the bottom portion 14b of the bottomed cylindrical case 14a presses a portion of the valve body 15c corresponding to the outside of the valve seat 11c.

This causes the valve body 15c to incline against the biasing force of the plate spring portions 15d, so that a gap occurs between the valve body 15c and the valve seat 11c of the first valve and the first valve 15 is opened.

Therefore, air in a space between the second valve 14 and the first valve 15 passes through the first valve 15, and is discharged into a container, not shown, via the second flow channel 11d and the first flow channel 11a.

Subsequently, in this state, when a finger is released from the trigger 12, the trigger 12 returns to the initial state before the air vent action is performed, namely, as shown in FIG. 1, according to the biasing force of the return plate spring 12a of the trigger 12, and the hollow piston 13 slides to the downstream side.

At this time, the bottomed cylindrical case 14a also slides to the downstream side together with the hollow piston 13.

A state where the bottomed cylindrical case 14a has been slid to the downstream side is shown in FIG. 1 and specifically, in FIG. 7(A), FIG. 8(A).

As shown in FIG. 7(A), FIG. 8(A), when the bottomed cylindrical case 14a slides to the downstream side, so that the pressing force to the valve body 15c from the bottom portion 14b of the bottomed cylindrical case 14a is lost, a face on the upstream side of the valve body 15c abuts on the valve sheet 11c of the first valve 15 according to the biasing force of the plate spring portions 15d and the first valve 15 is closed.

The trigger type sprayer 10 according to the embodiment of the present invention has the following advantageous effect.

The trigger type sprayer 10 includes a body 11 having a first flow channel 11a through which liquid can flow, a second flow channel 11d communicating with the first flow channel 11a, and a cylindrical cylinder chamber 11b communicating with the second flow channel 11d; a hollow piston 13 slidably incorporated into the cylinder chamber 11b, having a valve seat 13b and a hollow portion 13d of a second valve 14, and sliding back and forth according to operation of a trigger 12; the second valve 14 incorporated into the hollow piston 13 and positioned at a downstream side; and a first valve 15 incorporated into the cylinder chamber 11b and positioned at an upstream side, wherein the valve body 15c of the first valve 15 is pressed by the bottom portion 14b of the bottomed cylindrical case 14a of the second valve 14 so that the first valve 15 is opened.

Further, when the trigger 12 is pulled, the bottomed cylindrical case 14a of the second valve 14 slides to the upstream side together with the hollow piston 13, and the valve body 15c of the first valve 15 is pressed to be inclined by the bottom portion 14b of the bottomed cylindrical case 14a so that the first valve 15 is opened.

Therefore, air in a space between the second valve 14 and the first valve 15 passes through the first valve 15, and is discharged into a container, not shown, via the second flow channel 11d and the first flow channel 11a.

Further, since the second valve 14 is closed during discharge of air in a space between the second valve 14 and the first valve 15, namely, during air vent, liquid never leak from the nozzle 16.

Therefore, by several actions of fully pulling the trigger 12 (namely, several idle triggering actions), air vent in a space between the second valve 14 and the first valve 15 can be efficiently performed.

Further, after air vent is completed by performing the above-described several idle triggering actions of the trigger type sprayer 10 according to the embodiment of the present invention, normal delivery or spray of liquid is performed by subsequently performing the action of pulling the trigger 12.

It should be noted that the liquid sucked up from the container according to opening of the first valve 15 transfers to the second valve 14 side through the plurality of axial grooves 15b formed in the inner face of the cylindrical case 15a.

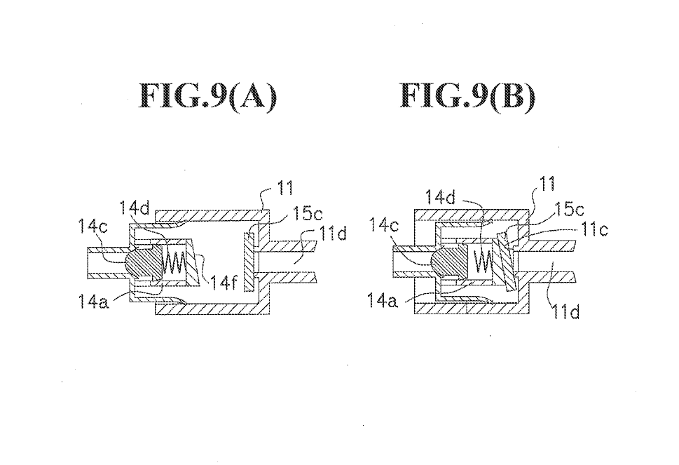

Next, first to fourth variations of the trigger type sprayer 10 according to an embodiment of the present invention will be described with reference to FIG. 9 to FIG. 12 schematically showing their actuations.

It should be noted that the cylindrical case 15a and/or the plate spring portion 15d of the first valve 15 are omitted for descriptive purposes.

FIGS. 9(A) and 9(B) schematically show the actuation of the first variation, FIG. 9(A) showing a state before the trigger 12 is pulled, FIG. 9(B) showing a state after the trigger 12 has been fully pulled.

In the first variation shown in FIGS. 9(A) and 9(B), a face on the upstream side of the bottom portion 14b of the bottomed cylinder case 14a of the second valve 14 is formed with an inclined face 14f.

Therefore, when the trigger 12 is fully pulled, the bottomed cylindrical case 14a slides to the upstream side in the cylinder chamber 11b of the body 11, and the inclined face 14f (higher portion) on the face on the upstream side of the bottom portion 14b of the bottomed cylindrical case 14a presses the valve body 15c.

That is, the higher portion of the inclined face 14f of the bottom portion 14b of the bottomed cylindrical case 14a presses a portion of the valve body 15c corresponding to the outside of the valve seat 11c.

Thereby, the valve body 15c is inclined.

Then, as shown in FIG. 9(B), a gap occurs between the valve body 15c and the valve seat 11c of the first valve 15, the first valve 15 is opened, and air is discharged into a container, not shown, via the second flow channel 11d and the first flow channel 11a.

Further, when the finger is released from the trigger 12, as shown in FIG. 9(A), an original state, namely, a state in which the valve body 15c abuts on the valve seat 11c according to a restorative force of a spring, not shown, is restored so that the first valve 15 is closed.

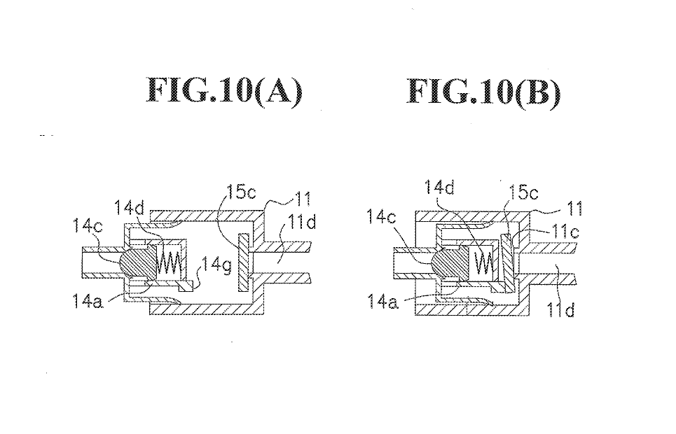

FIGS. 10(A) and 10(B) schematically show shows the actuation of the second variation, FIG. 10(A) showing a state before the trigger 12 is pulled, FIG. 10(B) showing a state after the trigger 12 has been fully pulled.

In the second variation shown in FIG. 10, a protrusion 14g is formed on the face on the upstream side of the bottom portion 14b of the bottomed cylindrical case 14a of the second valve 14.

Therefore, when the trigger 12 is fully pulled, the bottomed cylindrical case 14a slides to the upstream side in the cylinder chamber 11b of the body 11, and the protrusion 14g formed on the face on the upstream side of the bottom portion 14b of the bottomed cylindrical case 14a presses the valve body 15c.

That is, the protrusion 14g presses a portion of the valve body 15c corresponding to the outside of the valve seat 11c. Thereby, this valve body 15c is inclined.

Then, as shown in FIG. 10(B), a gap occurs between the valve body 15c and the valve seat 11c of the first valve 15, the first valve 15 is opened, and air is discharged into a container, not shown, via the second flow channel 11d and the first flow channel 11a.

Further, when the finger is released from the trigger 12, as shown in FIG. 10(A), an original state, namely, a state in which the valve body 15c abuts on the valve seat 11c according to a restorative force of a spring, not shown, is restored so that the first valve 15 is closed.

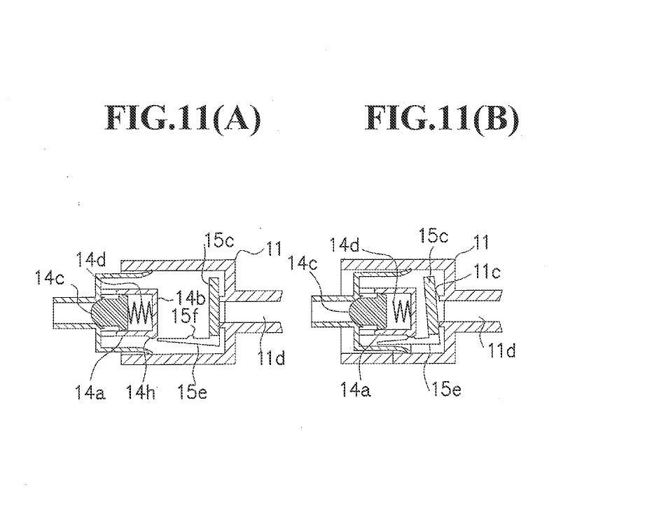

FIGS. 11(A) and 11(B) schematically show the actuation of the third variation, FIG. 11(A) showing a state before the trigger 12 is pulled, FIG. 1 (B) showing a state after the trigger 12 has been fully pulled.

In the third variation shown in FIGS. 11(A) and 11(B), a cam portion 14h is formed on the face on the upstream side of the bottom portion 14b of the bottomed cylindrical case 14a of the second valve 14, and a lever 15e provided with a cam portion 15f is attached to a side portion of the valve body 15c of the first valve 15 so as to extend downstream in a raised manner.

Therefore, when the trigger 12 is fully pulled, the bottomed cylindrical case 14a slides to the upstream side in the cylinder chamber 11b of the body 11, and a state shown in FIG. 11(B) in which the cam portion 14h on the bottomed cylindrical case 14a side and the cam portion 15f on the lever 15e side abut on each other is obtained.

In this state, the valve body 15c of the first valve 15 is inclined via the lever 15e.

Then, as shown in FIG. 11(B), a gap occurs between the valve body 15c and the valve seat 11c of the first valve 15, the first valve 15 is opened, and air is discharged into a container, not shown, via the second flow channel 11d and the first flow channel 11a.

Further, when the finger is released from the trigger 12, as shown in FIG. 11(A), an original state, namely, a state in which the abutting state between the cam portion 14h on the bottomed cylindrical case 14a side and the cam portion 15f on the lever 15e side have been released, and a state in which has caused the valve body 15c has abutted on the valve seat 11c according to a restorative force of a spring, not shown, is restored, so that the first valve 15 is closed.

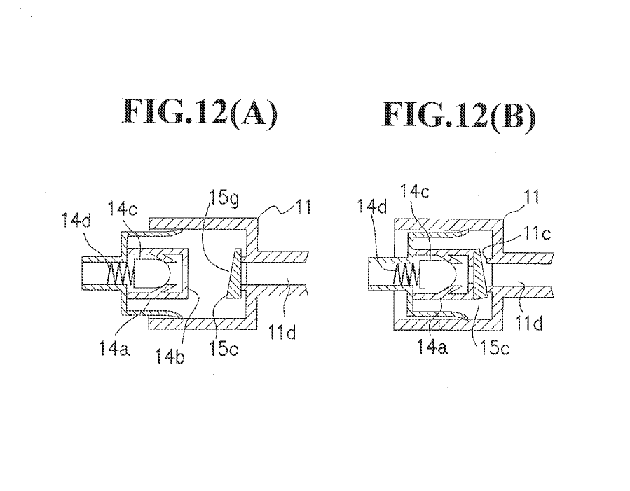

FIGS. 12(A) and 12(B) schematically show the actuation of the fourth variation, FIG. 12(A) showing a state before the trigger 12 is pulled. FIG. 12(B) showing a state after the trigger 12 is fully pulled.

In the fourth variation shown in FIGS. 12(A) and 12(B), the second valve 14 is of a direct pressure type having no pressure accumulation function, and the inclined face 15g is formed on the face on the downstream side of the valve body 15c of the first valve 15.

Therefore, when the trigger 12 is fully pulled, the bottomed cylindrical case 14a slides to the upstream side in the cylinder chamber 11b of the body 11, and the bottom portion 14b of the bottomed cylindrical case 14a presses a higher portion of the inclined face 15g on the face on the downstream side of the valve body 15c of the first valve 15.

That is, the bottom portion 14b of the bottomed cylindrical case 14a presses a portion of the valve body 15c corresponding to the outside of the valve seat 11c.

Thereby, this valve body 15c is inclined against a biasing force of a spring, not shown.

Then, as shown in FIG. 12(B), a gap occurs between the valve body 15c and the valve seat 11c of the first valve 15, the first valve 15 is opened, and air is discharged into a container, not shown, via the second flow channel 11d and the first flow channel 11a.

Further, when the finger is released from the trigger 12, as shown in FIG. 12(A), an original state, namely, a state in which the valve body 15c has abutted on the valve seat 11c according to a restorative force of a spring, not shown, is restored so that the first valve 15 is closed.

The first to fourth variations of the trigger type sprayer 10 according to the embodiment of the present invention also have a similar advantageous effect to the trigger type sprayer 10 according to the embodiment of the present invention.

As described above, a preferred embodiment of the present invention has been described, but the present invention is not necessarily limited to such an embodiment.

For example, various shapes can be adopted as a shape of each component of the trigger type sprayer 10 as long as an opening and closing principle of the first valve of the present invention can be applied to the shapes.

### INDUSTRIAL APPLICABILITY

The trigger type sprayer of the present invention has such a merit that air vent in a space between the second valve and the first valve can be easily performed.

The present invention can be applied not only to a trigger type pump dispenser but also to a push-type pump dispenser.

### REFERENCE SIGNS LIST

10 . . . trigger type sprayer,
11 . . . body,
11a . . . first flow channel,
11b . . . cylinder chamber,
11c . . . valve seat of first valve,
11d . . . second flow channel,
11e . . . secondary cylinder chamber,
11f . . . air flow channel,
12 . . . trigger,
12a . . . return plate spring,
12b . . . fitting portion,
12c . . . hinge portion,
13 . . . hollow piston,
13a . . . negative pressure relief piston,
13b . . . valve seat of second valve,
13c . . . pair of supporting shaft,
13d . . . hollow portion,
14 . . . second valve,
14a . . . bottomed cylindrical case,
14b . . . bottom portion of bottomed cylindrical case,
14c . . . valve body of second valve,
14d . . . spring biasing valve body,
14e . . . abutting portion abutting on bottom portion,
14f . . . inclined face of bottom portion of bottomed cylindrical case,
14g . . . protrusion of bottom portion of bottomed cylindrical case,
14h . . . cam portion of bottom portion of bottomed cylindrical case,
14j . . . hollow portion of bottomed cylindrical case,
15 . . . first valve,
15a . . . cylindrical case,
15b . . . a plurality of axial grooves formed in an inner face of cylindrical case,
15c . . . valve body of first valve,
15d . . . a plurality of plate spring portions biasing valve body,
15e . . . lever attached to valve body of first valve,
15f . . . cam portion provided on lever,
15g . . . inclined face of valve body of first valve,
16 . . . nozzle,
16a . . . nozzle cover,
17 . . . cover of body,
18 . . . cap,
19 . . . suction tube.

1. A trigger type sprayer comprising:
a body having a first flow channel through which liquid can flow, a second flow channel communicating with the first flow channel, and a cylindrical cylinder chamber communicating with the second flow channel;
a hollow piston slidably incorporated into the cylinder chamber, having a valve seat and a hollow portion of a second valve, and sliding back and forth according to operation of a trigger;
the second valve incorporated into the hollow portion of the hollow piston and positioned at a downstream side; and
a first valve incorporated into the cylinder chamber and positioned at an upstream side, wherein
the first valve is pressed by the second valve so that the first valve is opened.

2. The trigger type sprayer according to claim 1, wherein
the second valve has a pressure accumulation function, and is provided with a valve body, a spring, and a bottomed cylindrical case housing the valve body and the spring and attached inside the hollow portion, wherein
the first valve is provided with a cylindrical case, a downstream side of which is opened and an upstream side of which is attached in the cylinder chamber, and a valve body positioned at the upstream side of the cylindrical case, wherein
the bottomed cylindrical case is slidably incorporated into the cylindrical case, and slides back and forth together with the hollow piston according to operation of the trigger, and wherein
the valve body of the first valve is pressed and inclined by a bottom portion of the bottomed cylindrical case so that the first valve is opened.

3. The trigger type sprayer according to claim 2, wherein an inclined face is formed on a face on a downstream side of the valve body of the first valve.

4. The trigger type sprayer according to claim 2, wherein an inclined face is formed on a face on an upstream side of the bottom portion of the bottomed cylindrical case of the second valve.

5. The trigger type sprayer according to claim 2, wherein a protrusion is formed on a face on an upstream side of the bottom portion of the bottomed cylindrical case of the second valve.

6. The trigger type sprayer according to claim 2, wherein a cam portion is formed on a face on an upstream side of the bottom portion of the bottomed cylindrical case of the second valve, and a lever provided with a cam portion is attached to a side of the valve body of the first valve so as to extend downstream.

7. The trigger type sprayer according to claim 1, wherein the second valve is of a direct pressure type having no pressure accumulation function.
